(19) United States
(12) Patent Application Publication
(10) Pub. No.: US 2010/0268739 A1
(43) Pub. Date: Oct. 21, 2010

(54) SYSTEMS AND METHODS FOR AUTOMATICALLY DETECTING AND REMOVING REDIRECTED UNIFORM RESOURCE LOCATORS

(76) Inventor: George David Zalepa, New York, NY (US)

Correspondence Address: George David Zalepa, 90 William Street, Apt. 16E, New York, NY, 10038, US

(21) Appl. No.: 12/427,249

(22) Filed: Apr. 21, 2009

(51) Int. Cl. G06F 17/30

(52) U.S. Cl. 707/782; 707/E17.005; 707/E17.002

(57) ABSTRACT

The present invention is directed towards systems and methods for managing shortened URLs. The method according to one embodiment of the present invention comprises receiving a request for a shortened URL from a submitting user, said request comprising a first URL. The method then generates a unique shortened URL for said first URL and provides said shortened URL to the submitting user. After a period of time, the method receives a request for the shortened URL from a requesting user. The method then deletes the shortened URL and redirects the requesting user to the first URL.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments of the invention described herein generally relate to the optimization of URL aliasing. More specifically, embodiments of the present invention are directed towards systems and methods for automatically maintaining a URL alias database.

### BACKGROUND OF THE INVENTION

As the Internet continues to grow, the amount of content available to regular users exponentially increases. The dynamic nature of websites originally resulted in cryptic URLs such as “http://www.example.com/article.php?id=23582sja&category=2300031&subcategory=2190P”. The following example illustrates the concept of “query pairs” wherein data may be submitted to a web application. Query pairs represent a fundamental concept in supplying data to web applications. During the early growth of the Internet the presence of these query pairs was accepted as a necessary downfall of dynamic programming. However, as search engine optimization, among other technologies, proliferated, website owners desired to replace these cryptic query pairs with more descriptive language. Thus, many sites began incorporating longer URLs replacing query-pairs with description text, such as: http://www.example.com/articles/recent/november/05/2008/cat-rescues-boy-down-well. Clearly, the second URL provides more descriptive information than the first, and thus provides a more user friendly URL.

However, as the length of URLs increased, a smaller subset of users desired shorter URLs. Thus, various services (e.g., TinyURL) began to offer URL redirection services. The general state of the art follows a model that allows users to input a URL and receive a substantially shortened URL. For example the previous example may be shortened to http://www.short.xyz/k3sga. Where “k3sga” represents a hash table entry that redirects a user to the desired URL.

The current state of the art provides URL shortening with little, or more often, no options. All URL shortening services currently store URL redirection in upwards of one to two weeks. While storing of URLs for an indeterminate amount of time may be desirable in some situations, many situations exist where a user would not want a record of his or her shortened links. Thus, there currently exists a need in the art for a URL shortening service allowing heightened security and privacy for users.

### SUMMARY OF THE INVENTION

The present invention is directed towards systems and methods for . . . . The method of the present invention comprises receiving a request for a shortened URL from a submitting user, said request comprising a first URL. The method then generates a unique shortened URL for said first URL and provides said shortened URL to the submitting user. After a period of time, the method receives a request for the shortened URL from a requesting user. The method then deletes the shortened URL and redirects the requesting user to the first URL.

In alternative embodiment the method may further determine if the requested shortened URL exists and may delete the shortened URL immediately after determining that the requested shortened URL exists. In a first embodiment, deleting the shortened URL comprising removing the shortened URL from a database. In a second embodiment, deleting the shortened URL comprises marking the shortened URL as deleted. In a third embodiment, deleting the shortened URL comprises determining an expiration period and deleting the shortened URL after the expiration of the expiration period. Receiving a request for a shortened URL may also comprise receiving a communication identifier associated with the requesting user. In this embodiment, the method further comprises alerting the user upon deleting the shortened URL via the communication identifier wherein the communication identifier comprises one of an e-mail address, phone number or instant messenger identifier.

The system of the present invention comprises a plurality of client devices coupled to a network, said client devices operative to transmit a request for a shortened URL from a submitting user, said request comprising a first URL. The system further comprises a URL database operative to store shortened URLs, said URL database operative to store at least a URL and a URL identifier. Finally, the system also comprises a content server operative to generate a unique shortened URL for said first URL; provide said shortened URL to the submitting user; receive a request for the shortened URL from a requesting user; delete the shortened URL; and redirect the requesting user to the first URL.

In one embodiment, the content server is further operative to determine if the requested shortened URL exists wherein deleting the shortened URL occurs immediately after determining that the requested shortened URL exists. In a first embodiment, deleting the shortened URL comprising removing the shortened URL from a database. In a second embodiment, deleting the shortened URL comprises marking the shortened URL as deleted. In a third embodiment, deleting the shortened URL comprises determining an expiration period and deleting the shortened URL after the expiration of the expiration period. In one embodiment, receiving a request for a shortened URL further comprises receiving a communication identifier associated with the requesting user. In this embodiment, the system further comprises alerting the user upon deleting the shortened URL via the communication identifier wherein the communication identifier comprises one of an e-mail address, phone number or instant messenger identifier.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for generating and monitoring shortened URLs according to one embodiment of the present invention; and

FIG. 2 presents a flow diagram depicting a method for generating a shortened URL according to one embodiment of the present invention; and

FIG. 3 presents a flow diagram depicting a method for detecting and removing a shortened URL according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

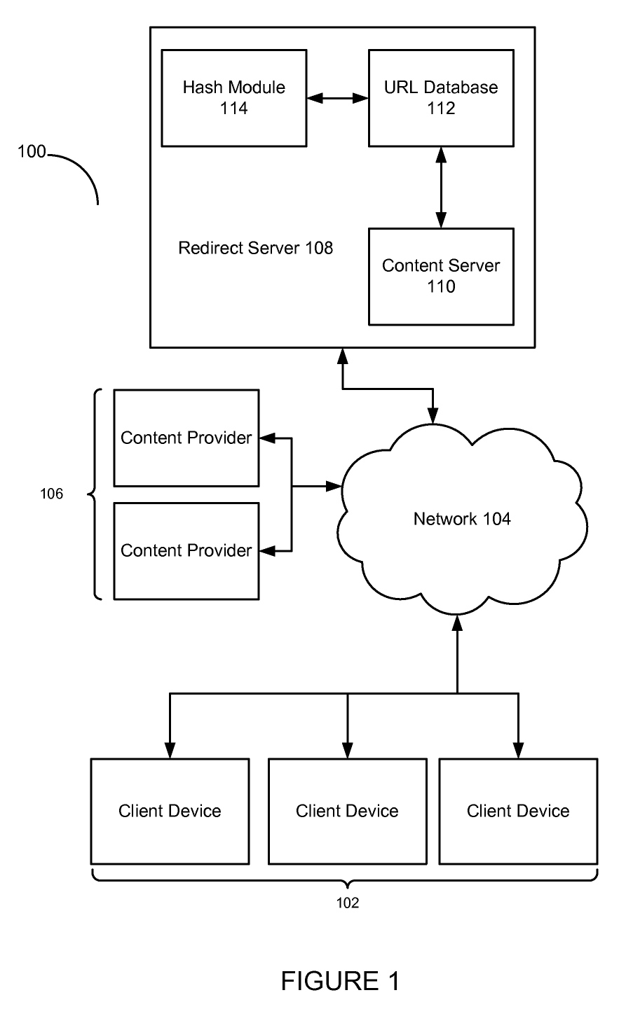

FIG. 1 presents a block diagram depicting a system for generating and monitoring shortened URLs according to one embodiment of the present invention. As illustrated, the system 100 comprises a plurality of client devices 102 connected to a redirect server 108 and a plurality of content providers 106 via a network 104. Additionally, redirect server 108 comprises a content server 110, URL database 112 and hash module 114.

Client devices 102 may comprise general purpose computing (mobile or otherwise) devices having a central processing unit, memory unit, permanent storage, optical drive(s), universal serial bus port(s), audio/video output devices, network interfaces, etc. Client devices 102 are operative to communicate via network 104, which may comprise a local or wide area network such as the Internet. In the present embodiment, client devices 102 transmit requests to redirect server 108 and content providers 106 via the HTTP, WAP or similar protocol for the client/server exchange of text, images and other data. In the illustrated embodiment, content providers 106 may be identified via a uniform resource locator (“URL”).

Redirect server 108 comprises a content server 110 operative to receive requests for data from client devices 102. Redirect server 108 may receive a plurality of requests including, but not limited to, requests for URL shortening and requests for shortened URLs.

In a first embodiment, redirect server 108 may be operative to receive a request for URL shortening and may query URL database 112 to determine if the requested URL has already been shortened. The content server 110 may then generate a unique identifier for the requested URL, if the URL does not already exist in URL database 112. In one embodiment, generating a unique identifier may comprise generating a multi-byte alphanumeric code. The redirect server 108 may then be operative to transmit the unique identifier to client devices 102.

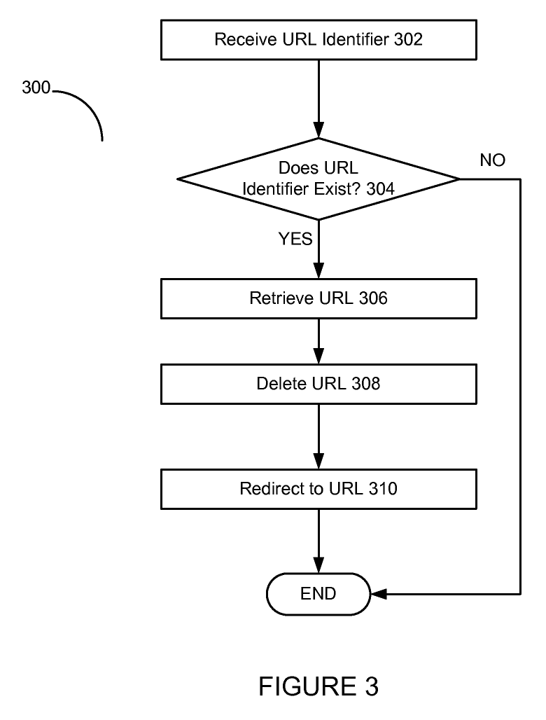

In a second embodiment, content server 110 may further be operative to receive a request for a URL containing a unique identifier. In this embodiment, the content server 110 may query the URL database 112 and may extract a URL corresponding to the unique identifier. After retrieving a URL, the content server 110 may then delete the URL from URL database 112. In one embodiment deleting a URL may comprise deleting a row from URL database 112 associated with the unique identifier. The content server 110 may then be operative to redirect the requesting client device 102 to the retrieved URL. Further embodiments relating to URL redirection are discussed more fully with respect to FIG. 3.

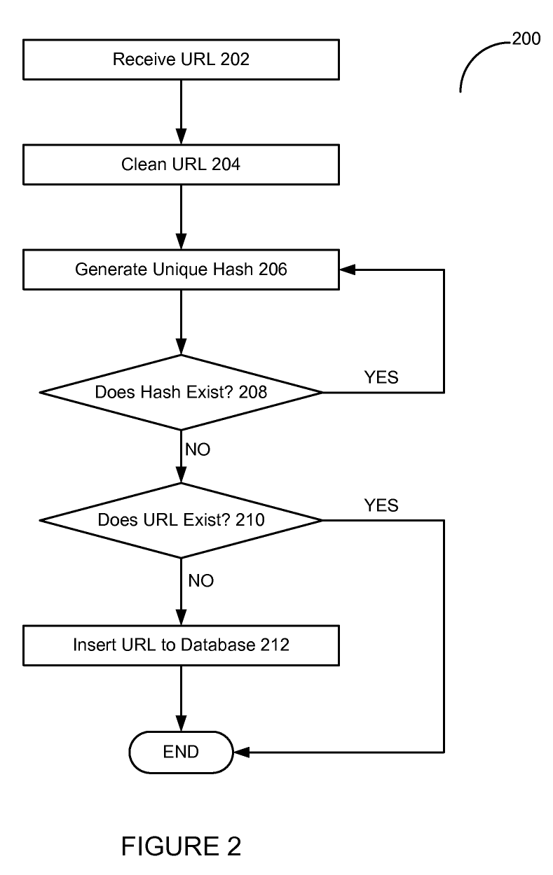

FIG. 2 presents a flow diagram depicting a method for generating a shortened URL according to one embodiment of the present invention. As illustrated, the method 200 receives a URL 202. In one embodiment, the method 200 receives a URL via a web form wherein the URL comprises a user-supplied URL. For example, a user may navigate to a predefined URL wherein he or she may enter in a requested URL (e.g., “http://www.example.com”). The user may then submit the entered URL to a redirect server via a submit button, key press or similar means.

After submitting a URL, the method 200 then cleans the received URL, step 204. In one embodiment, cleaning a URL may comprise removing whitespace and illegal characters from the URL. In an alternative embodiment, cleaning a URL may comprise comparing the URL to a list of stop URLs or banned URLs. For example, the method 200 may wish to ignore common URLs such as search portals. In another embodiment, method 200 may additionally perform various checks to determine if the received URL follows a predefined schema. For example, method 200 may determine if the URL begins with “http://” or “mailto:” (i.e., limiting URL by protocol).

The method 200 then generates a unique hash for the cleaned URL, step 206. In one embodiment, a unique hash comprises a multi-byte alphanumeric hash value unique to a submitted URL. The method 200 may generate a hash value according to various hashing schemes known in the art. The method 200 then determines if the hash exists, step 208. In one embodiment, the method 200 may query a database to determine if a given hash value has already been stored by the method 200. If so, the method 200 then generates a different hash step 206. Steps 206 and 208 repeat until a unique hash is generated for a given URL.

After generating a unique hash, the method 200 then determines if the submitted URL exists, step 210. In one embodiment, determining if a URL exists comprises querying a URL table to determine if another user has previously submitted the submitted URL. If the method 200 determines the URL exists, the method 200 ends. Alternatively, the method may present the user with a shortened URL, previously stored by the method 200.

If the method 200 determines the submitted URL does not exist in the database, the method 200 inserts the URL into the database. In one embodiment, inserting a URL may comprise inserting the unique identifier and the URL. In alternative embodiment, various other data may be stored including, but not limited to, a submission timestamp, submitter e-mail address or various other control parameters received by the method 200.

Finally, the method 200 ends after inserting the URL. In one embodiment, the method 200 may display information to the user in response to the previous insertion. In this embodiment, the method 200 may display the shortened URL, the shortened URL including the unique identifier previously generated.

FIG. 3 presents a flow diagram depicting a method for detecting and removing a shortened URL according to one embodiment of the present invention. As the embodiment of FIG. 3 illustrates, the method 300 receives a URL identifier, step 302. Receiving a URL identifier may comprise receiving an HTTP request containing a unique hash identifier. In one embodiment, a hash identifier may be transmitted via a name value pair such as “http://example.com/?url=2fcfe892”. In an alternative embodiment, the method 300 may be operative to example a URL to extract the hash identifier. For example, a URL may comprise “http://example.com/2fcfe892” wherein the method 300 may extract the identifier “2fcfe892” from the URL.

The method 300 may then determine if the URL identifier exists, step 304. In one embodiment, determining if the URL identifier exists may comprise querying a URL table to determine if the requested identifier has actually been inserted into a database. Step 304 primarily determines if the user has submitted a fraudulent or erroneous identifier, however various other determinations may be made. If the method 300 determines the identifier does not exist, the method 300 ends. Alternatively, the method 300 may alert the user about the unknown identifier.

If the method 300 determines that a URL exists for given identifier, the method 300 retrieves the URL associated with the identifier, step 306. In one embodiment, retrieving a URL associated with the identifier may comprise querying a URL database and retrieving the URL text associated with the identifier. Assuming the method 300 successfully retrieves the URL text, the method 300 deletes the URL entry from the URL database, step 308. Deleting a URL may comprise simply removing the database record from the URL database. In an alternative embodiment, deleting a URL may comprise marking a “dirty” bit or similar mechanism to softly delete the URL. In this embodiment, a scheduled process may remove the marked URLs at a predetermined interval. It should be noted, softly deleting a URL may require the method 300 to additionally determine if the entry has been softly deleted prior to proceeding to step 306.

Additional embodiments of FIG. 3 may also be considered with respect to deletion of URLs. In one embodiment, the method 300, in addition to deleting a URL, may also alert the submitting user that the URL has been deleted. For example, when a user submits a URL to be shortened, he or she may supply an contact e-mail address. When the user sends the shortened link, and a second user clicks on it, the method 300 may send an e-mail (or similar means such as text, IM, etc) to the submitting user alerting him or her that his or her link was clicked and deleted.

In yet another alternative, the submitting user may provide a plurality of control flags or options to control the deletion process. For example, the user may explicitly select the number of minutes, hours, days or weeks he or she wishes the shortened URL to remain active. In this embodiment, the soft deletion process would mark a separate field indicating when the URL should be deleted. In this manner, a given user may be operable to create a shortened URL campaign. In one embodiment, a user may be operative to create and manage a shortened URL campaign via a web-based administration GUI. For example, a user may be presented with a webpage allowing him or her to create a plurality of shortened URLs as described with respect to FIG. 2. The user may have a user account allowing him or her to log in and view the shortened URLs he or she created. The GUI may display various parameters such as (1) the URLs a user has created, (2) whether the link has been activated or (3) the time left in the link life (e.g., the expiration date).

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

I claim:

1. A method for managing shortened URLs, the method comprising:
receiving a request for a shortened URL from a submitting user, said request comprising a first URL;
generating a unique shortened URL for said first URL;
providing said shortened URL to the submitting user;
receiving a request for the shortened URL from a requesting user;
deleting the shortened URL; and
redirecting the requesting user to the first URL.

2. The method of claim 1 further comprising determining if the requested shortened URL exists.

3. The method of claim 2 wherein deleting the shortened URL occurs immediately after determining that the requested shortened URL exists.

4. The method of claim 1 wherein deleting the shortened URL comprises removing the shortened URL from a database.

5. The method of claim 1 wherein deleting the shortened URL comprises marking the shortened URL as deleted.

6. The method of claim 1 wherein deleting the shortened URL comprises determining an expiration period and deleting the shortened URL after the expiration of the expiration period.

7. The method of claim 1 wherein receiving a request for a shortened URL further comprises receiving a communication identifier associated with the requesting user.

8. The method of claim 7, further comprising alerting the user upon deleting the shortened URL via the communication identifier.

9. The method of claim 8 wherein the communication identifier comprises one of an e-mail address, phone number or instant messenger identifier.

10. A system for managing shortened URLs, the system comprising:
a plurality of client devices coupled to a network, said client devices operative to transmit a request for a shortened URL from a submitting user, said request comprising a first URL;
a URL database operative to store shortened URLs, said URL database operative to store at least a URL and a URL identifier;
a content server operative to:
generate a unique shortened URL for said first URL;
provide said shortened URL to the submitting user;
receive a request for the shortened URL from a requesting user;
delete the shortened URL; and
redirect the requesting user to the first URL

11. The system of claim 10 wherein the content server is further operative to determine if the requested shortened URL exists.

12. The system of claim 11 wherein the content server is further operative to delete the shortened URL immediately after determining that the requested shortened URL exists.

13. The system of claim 10 wherein the content server is further operative to delete the shortened URL by removing the shortened URL from a database.

14. The system of claim 10 wherein the content server is further operative to delete the shortened URL by marking the shortened URL as deleted.

15. The system of claim 10 wherein the content server is further operative to delete the shortened URL by determining an expiration period and deleting the shortened URL after the expiration of the expiration period.

16. The system of claim 10 wherein the client devices are further operative to transmit a communication identifier associated with the requesting user.

17. The system of claim 16, wherein the content server is further operative to alert the user upon deleting the shortened URL via the communication identifier.

18. The system of claim 17 wherein the communication identifier comprises one of an e-mail address, phone number or instant messenger identifier.
